(19) United States
(12) Patent Application Publication
(10) Pub. No.: US 2025/0356261 A1
(43) Pub. Date: Nov. 20, 2025

(54) METHOD FOR TUNING LANGUAGE MODEL TO GENERATE CODE AND SYSTEM FOR THE SAME

(71) Applicants: SAMSUNG SDS CO., LTD., Seoul (KR); Seoul National University R&DB Foundation, Seoul (KR)

(72) Inventors: Jae Seong LEE, Seoul (KR); Ho Jae HAN, Seoul (KR); Na Un KANG, Seoul (KR); Seung Won HWANG, Seoul (KR); Kyung Jun AN, Seoul (KR); Sung Ho JANG, Seoul (KR)

(73) Assignees: SAMSUNG SDS CO., LTD., Seoul (KR); Seoul National University R&DB Foundation, Seoul (KR)

(21) Appl. No.: 19/206,691

(22) Filed: May 13, 2025

(30) Foreign Application Priority Data
May 17, 2024 (KR) 10-2024-0064283
Oct. 30, 2024 (KR) 10-2024-0150999

(51) Int. Cl. G06N 20/00; G06F 8/10; G06F 8/35

(52) U.S. Cl. CPC G06N 20/00; G06F 8/10; G06F 8/35

(57) ABSTRACT

A method for tuning a language model is provided. The method may be performed by a computing device, and may comprise: receiving, from a user, a coding requirement and a target programming language to be input into a first model, wherein the first model is a model trained to output a code snippet corresponding to the received coding requirement in the target programming language; determining whether the target programming language is in-domain or out-of-domain with respect to the first model; and updating pretrained parameters of the first model based on a result of the determination and a masking result of the pretrained parameters, wherein the updating the pretrained parameters comprises: updating pretrained parameters of all layers of the first model when the target programming language is in-domain; and updating pretrained parameters of a dense layer of the first model when the target programming language is out-of-domain.

### CROSS-REFERENCE TO RELATED APPLICATION(S)

This application claims priority from Korean Patent Application No. 10-2024-0064283 filed on May 17, 2024 and No. 10-2024-0150999 filed on Oct. 30, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method for tuning a language model to generate code and a system for the same, and more specifically, to a method for adjusting the parameters of a language model to achieve high code generation performance regardless of the type of programming language a user intends to use.

### 2. Description of the Related Art

Recently, trained language models have played a central role in code snippet generation tasks. Therefore, tuning a language model to achieve good performance in a target programming language is one of the most critical challenges. Given the vast number of programming languages, training a language model on as many programming languages as possible can improve performance across various programming languages. However, training too many programming languages within a constrained model can cause negative, leading to performance degradation. To mitigate this, increasing the model size may be considered a solution, but may result in a linear increase in the time required for model training and inference.

As an alternative, parameter-efficient fine-tuning (PEFT) methods, which involve training only a subset of a language model's parameters and performing additional fine-tuning for a target programming language during inference, are frequently used to tailor the language model to the target programming language. Among these methods, low-rank adaptation (LoRA) reduces the dimensionality of dense layers for computation, enabling performance comparable to full fine-tuning while improving computational efficiency and reducing memory usage. However, this dimensionality reduction can overly simplify the language model, limiting its ability to achieve optimal performance for the target programming language. Accordingly, a method is needed to enhance computational efficiency while preserving critical information in dense layers.

### SUMMARY

An objective of the present disclosure is to provide a method that enables an efficient parameter update in a dense layer, which contains a large amount of critical information in a language model, regardless of whether a programming language is in-domain or out-of-domain with respect to the language model.

Another objective of the present disclosure is to provide a method that enables an efficient parameter update in a dense layer, even in a large language model (LLM), by utilizing a low-rank update.

The objectives of the present disclosure are not limited to those mentioned above, and other objectives not explicitly stated will be clearly understood by those skilled in the art based on the following description.

According to an aspect of the present disclosure, there is provided a method for tuning a language model. The method may be performed by a computing device, and may comprise: receiving, from a user, a coding requirement and a target programming language to be input into a first model, wherein the first model is a model trained to output a code snippet corresponding to the received coding requirement in the target programming language; determining whether the target programming language is in-domain or out-of-domain with respect to the first model; and updating pretrained parameters of the first model based on a result of the determination and a masking result of the pretrained parameters, wherein the updating the pretrained parameters comprises: updating pretrained parameters of all layers of the first model when the target programming language is in-domain; and updating pretrained parameters of a dense layer of the first model when the target programming language is out-of-domain.

In one embodiment, the determining whether the target programming language is in-domain or out-of-domain may comprise: determining that the target programming language is in-domain when an accuracy of a previously generated code snippet in the target programming language is equal to or greater than a predefined threshold accuracy; and determining that the target programming language is out-of-domain when the accuracy of the previously generated code snippet is below the predefined threshold accuracy.

In one embodiment, the determining whether the target programming language is in-domain or out-of-domain may comprise: determining that the target programming language is in-domain when the target programming language has been used in training the first model; and determining that the target programming language is out-of-domain when the target programming language has not been used in training the first model.

In one embodiment, the masking result may be a result in which, among the pretrained parameters, parameters whose variation, as a result of a previously performed full fine-tuning on the first model, is equal to or greater than a predefined threshold variation are masked as 1, and parameters whose variation is below the predefined threshold variation are masked as 0.

In one embodiment, when a number of pretrained parameters of the first model exceeds a predefined threshold, the full fine-tuning may be performed in advance using a low-rank update on a weight of the dense layer of the first model.

In one embodiment, the updating the pretrained parameters may comprise: determining whether there exists a first masking result previously generated during training of the first model using a first coding requirement and a first programming language, wherein the first coding requirement is a requirement having a similarity equal to or greater than a predefined threshold similarity to the received coding requirement, and the first programming language is the same as the target programming language; and when the first masking result exists, determining the first masking result as the masking result, and when the first masking result does not exist, performing a full fine-tuning on the first model and generating the masking result by masking, among the pretrained parameters, parameters whose variation, as a result of the full fine-tuning, is equal to or greater than a predefined threshold variation as 1 and parameters whose variation is below the predefined threshold variation as 0.

In one embodiment, the updating the pretrained parameters may comprise: determining variations of the pretrained parameters; and updating the pretrained parameters based on element-wise multiplication of the determined variations and the masking result.

According to another aspect of the present disclosure, there is provided a system for tuning a language model. The system may comprise: a processor; and a memory storing instructions, wherein the instructions, when executed by the processor, may cause the processor to: receive, from a user, a coding requirement and a target programming language to be input into a first model, wherein the first model is a model trained to output a code snippet corresponding to the received coding requirement in the target programming language; determine whether the target programming language is in-domain or out-of-domain with respect to the first model; and update pretrained parameters of the first model based on a result of the determination and a masking result of the pretrained parameters, wherein the updating the pretrained parameters comprises: updating pretrained parameters of all layers of the first model when the target programming language is in-domain; and updating pretrained parameters of a dense layer of the first model when the target programming language is out-of-domain.

In one embodiment, the determining whether the target programming language is in-domain or out-of-domain may comprise: determining that the target programming language is in-domain when an accuracy of a previously generated code snippet in the target programming language is equal to or greater than a predefined threshold accuracy; and determining that the target programming language is out-of-domain when the accuracy of the previously generated code snippet is below the predefined threshold accuracy.

In one embodiment, the determining whether the target programming language is in-

domain or out-of-domain may comprise: determining that the target programming language is in-domain when the target programming language has been used in training the first model; and determining that the target programming language is out-of-domain when the target programming language has not been used in training the first model.

In one embodiment, the masking result may be a result in which, among the pretrained parameters, parameters whose variation, as a result of a previously performed full fine-tuning on the first model, is equal to or greater than a predefined threshold variation are masked as 1, and parameters whose variation is below the predefined threshold variation are masked as 0.

In one embodiment, when a number of pretrained parameters of the first model exceeds a predefined threshold, the full fine-tuning may be performed in advance using a low-rank update on a weight of the dense layer of the first model.

In one embodiment, the updating the pretrained parameters may comprise: determining whether there exists a first masking result previously generated during training of the first model using a first coding requirement and a first programming language, wherein the first coding requirement is a requirement having a similarity equal to or greater than a predefined threshold similarity to the received coding requirement, and the first programming language is the same as the target programming language; and when the first masking result exists, determining the first masking result as the masking result, and when the first masking result does not exist, performing a full fine-tuning on the first model and generating the masking result by masking, among the pretrained parameters, parameters whose variation, as a result of the full fine-tuning, is equal to or greater than a predefined threshold variation as 1 and parameters whose variation is below the predefined threshold variation as 0.

In one embodiment, the updating the pretrained parameters may comprise: determining variations of the pretrained parameters; and updating the pretrained parameters based on element-wise multiplication of the determined variations and the masking result.

According to still another aspect of the present disclosure, there is provided a non-transitory computer-readable recording medium. The computer-readable recording medium stores instructions that, when executed in conjunction with a computing device, may cause the computing device to: receive, from a user, a coding requirement and a target programming language to be input into a first model, wherein the first model is a model trained to output a code snippet corresponding to the coding requirement in the target programming language; determine whether the target programming language is in-domain or out-of-domain with respect to the first model; and update pretrained parameters of the first model based on a result of the determination and a masking result of the pretrained parameters, wherein the updating the pretrained parameters comprises: updating pretrained parameters of all layers of the first model when the target programming language is in-domain; and updating pretrained parameters of a dense layer of the first model when the target programming language is out-of-domain.

In one embodiment, the determining whether the target programming language is in-domain or out-of-domain may comprise: determining that the target programming language is in-domain when an accuracy of a previously generated code snippet in the target programming language is equal to or greater than a predefined threshold accuracy; and determining that the target programming language is out-of-domain when the accuracy of the previously generated code snippet is below the predefined threshold accuracy.

In one embodiment, the determining whether the target programming language is in-domain or out-of-domain may comprise: determining that the target programming language is in-domain when the target programming language has been used in training the first model; and determining that the target programming language is out-of-domain when the target programming language has not been used in training the first model.

In one embodiment, the masking result may be a result in which, among the pretrained parameters, parameters whose variation, as a result of a previously performed full fine-tuning on the first model, is equal to or greater than a predefined threshold variation are masked as 1, and parameters whose variation is below the predefined threshold variation are masked as 0.

In one embodiment, when a number of pretrained parameters of the first model exceeds a predefined threshold, the full fine-tuning may be performed in advance using a low-rank update on a weight of the dense layer of the first model.

In one embodiment, the updating the pretrained parameters may comprise: determining whether there exists a first masking result previously generated during training of the first model using a first coding requirement and a first programming language, wherein the first coding requirement is a requirement having a similarity equal to or greater than a predefined threshold similarity to the received coding requirement, and the first programming language is the same as the target programming language; and when the first masking result exists, determining the first masking result as the masking result, and when the first masking result does not exist, performing a full fine-tuning on the first model and generating the masking result by masking, among the pretrained parameters, parameters whose variation, as a result of the full fine-tuning, is equal to or greater than a predefined threshold variation as 1 and parameters whose variation is below the predefined threshold variation as 0.

In one embodiment, the updating the pretrained parameters may comprise: determining variations of the pretrained parameters; and updating the pretrained parameters based on element-wise multiplication of the determined variations and the masking result.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a block diagram illustrating an exemplary configuration of an overall system according to an embodiment of the present disclosure;

FIG. 2 is a flowchart illustrating a method for tuning a language model according to an embodiment of the present disclosure;

FIG. 3 is a flowchart illustrating an embodiment of the step of determining whether a target programming language is in-domain or out-of-domain in FIG. 2;

FIG. 4 is a flowchart illustrating another embodiment of the step of determining whether a target programming language is in-domain or out-of-domain in FIG. 2;

FIG. 5 is a flowchart illustrating an embodiment of the step of updating a pretrained parameter in FIG. 2;

FIG. 6 is a flowchart illustrating another embodiment of the step of updating a pretrained parameter in FIG. 2;

FIG. 7 shows the effects of methods for tuning a language model according to embodiments of the present disclosure for each programming language; and

FIG. 8 is a block diagram illustrating the hardware configuration of a computing device including a language model according to an embodiment of the present disclosure.

### DETAILED DESCRIPTION

Preferred embodiments of the present disclosure will hereinafter be described in detail with reference to the accompanying drawings. The advantages, features, and methods of achieving them of the present disclosure will become clearer with the embodiments described in detail along with the accompanying drawings. However, the present disclosure is not limited to the embodiments described below and can be implemented in various different forms. These embodiments are provided only to make the disclosure complete and fully inform those of ordinary skill in the technical field to which the present disclosure belongs, and the present disclosure is defined only by the scope of the claims.

It is noted that the same reference numerals are used for the same elements across different drawings as far as possible. Furthermore, in describing the present disclosure, detailed descriptions of known configurations or functions will be omitted when they may obscure the essence of the present disclosure.

Unless defined otherwise, all terms used herein (including technical and scientific terms) can have the meaning commonly understood by one of ordinary skill in the art to which the present disclosure belongs. Terms defined in commonly used dictionaries are not interpreted in an ideal or excessive manner unless explicitly defined otherwise. The terms used in the present specification are for the purpose of describing particular embodiments only and are not intended to limit the invention. In this specification, the singular forms include plural forms unless the context clearly indicates otherwise.

Furthermore, in describing the components of the present disclosure, terms such as first, second, A, B, (a), (b), etc., may be used. These terms are intended to distinguish the components from others, and the essence, order, or sequence of such components is not limited by these terms. If a component is stated as being “connected,” “coupled,” or “linked” to another component, the component can be directly connected or linked to the other component, but it should be understood that there may also exist other components “connected,” “coupled,” or “linked between them.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

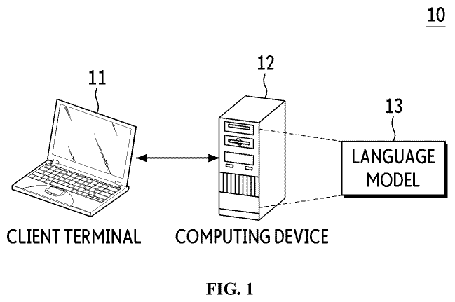

FIG. 1 is a block diagram illustrating an exemplary configuration of an overall system 10 according to an embodiment of the present disclosure. Referring to FIG. 1, the overall system 10 may include a client terminal 11 and a computing device 12. Additionally, the computing device 12 may include a language model 13.

The language model 13 refers to a neural network model trained on a vast amount of text (e.g., text from various domains) to acquire a universal understanding of a language (or natural language/text). In particular, the language model 13 is a neural network model trained to generate a code snippet by receiving, from a user, a coding requirement and a programming language as input through a text-based interface for queries and responses. Depending on the amount of training data and the size of parameters, the language model 13 may be referred to as a large-scale language model (LLM). Here, the coding requirement may include details such as what data is to be received as input when implemented as code, what type of operation is to be performed on input data, what data is to be output as a result of the operation, and what interface is to be provided to the user.

The client terminal 11 is a terminal used by the user to communicate with the computing device 12 and perform a specific task using the language model 13. For example, the user may input the coding requirement and a target programming language into the language model 13 of the computing device 12 via the client terminal 11. In response, the language model 13 may output a code snippet written in the target programming language that includes the input coding requirement. The client terminal 11 may include a device such as a smartphone, a tablet PC, or a laptop, but the present disclosure is not limited thereto. The client terminal 11 may include any type of computing device equipped with computational and communication capabilities.

The computing device 12 may execute the language model 13 in response to a user request (or prompt) from the client terminal 11. Additionally, the computing device 12 may adjust the parameters of the language model 13 to improve the accuracy of a code snippet generated through the inference process of the language model 13. When adjusting the parameters of the language model 13, the computing device 12 may first determine whether the target programming language specified by the user is in-domain or out-of-domain with respect to the language model 13.

In some embodiments, if the target programming language input by the user has already been used in the training of the language model 13, it may be determined as an in-domain language. On the other hand, if the target programming language input by the user has not been used in the training of the language model 13, it may be determined as an out-of-domain language. This criterion may be valid when only a limited number of programming languages have been used for training the language model 13. However, as the size of the language model 13 increases (i.e., as it approaches a large-scale language model LLM), it becomes more likely that most programming languages have been used to some extent in training, making it difficult to classify in-domain and out-of-domain languages based solely on this criterion.

Accordingly, in other embodiments, a determination may be made as to whether the target programming language is in-domain or out-of-domain based on the average accuracy of previously generated code snippets written in the target programming language. For example, if the accuracy of code snippets previously written in the target programming language and input by the user is equal to or greater than a predefined threshold accuracy, the target programming language may be determined as in-domain. Conversely, if the accuracy of such code snippets falls below the predefined threshold accuracy, the target programming language may be determined as out-of-domain. This criterion is generally applicable when the language model 13 is an LLM, but the present disclosure is not limited thereto. That is, the same criterion may also be applied to a language model 13 trained on only a small number of programming languages.

The computing device 12 may update pretrained parameters of the language model 13 based on the determination of whether the target programming language is in-domain or out-of-domain with respect to the language model 13 and the masking result of the pretrained parameters of the language model 13. It will hereinafter be described how to adjust the language model 13 according to an embodiment of the present disclosure.

First, the generation of the masking result of the pretrained parameters of the

language model 13 will be explained. The masking result of the pretrained parameters of the language model 13 may be obtained by performing full fine-tuning on the language model 13 and then masking, among the pretrained parameters of the language model 130, those whose variation is equal to or greater than a predefined threshold variation as 1 and those whose variation is below the predefined threshold variation as 0. A matrix representing the masking result of the pretrained parameters of the language model 13 may have the same dimensions as a matrix representing the pretrained parameters of the language model 13.

Various masking results may be generated and stored in advance in an external storage or memory (not illustrated), depending on the input coding requirement and the target programming language used in the training of the language model 13. Specifically, the computing device 12 may determine whether there exists a first masking result previously generated by performing fine-tuning on the language model 13 using a first coding requirement with a similarity exceeding a predefined threshold similarity to the input coding requirement and a first programming language identical to the target programming language. For example, the similarity between coding requirements may be calculated by converting the coding requirements into word embedding vectors and measuring the similarity between the word embedding vectors (e.g., a geometric distance between the word embedding vectors).

If there exists the first masking result, the first masking result may be used as the masking result for a parameter update. Conversely, if the first masking result does not exist, the computing device 12 may newly perform full fine-tuning on the language model 13 using the input coding requirement and the target programming language and generate a masking result based on the variations of the pretrained parameters as described above. When there exists an available masking result among the previously generated masking results, using the available masking result as is can reduce the computational time required for full fine-tuning.

Once the masking result to be used in the adjustment process of the language model 13 is determined, the computing device 12 may update the pretrained parameters of the language model 13 as shown in Equation 1 below.

$$f ( θ ) = θ + Δθ ⊙ m \qquad [ Equation 1 ]$$

Here, f(θ) represents the result of the parameter update, θ denotes the pretrained parameters, Δθ is the determined variations of the pretrained parameters θ, and m corresponds to the masking result of the pretrained parameters θ. Δθ ⊙ m refers to the element-wise multiplication of Δθ and m. That is, after determining the variations of parameters to be updated, the computing device 12 performs element-wise multiplication between the parameters to be updated and their masking result, thereby adjusting the language model 13 such that only the parameter masked as 1 may be updated while keeping the parameters masked as 0 unchanged.

Specifically, the computing device 12 may adjust the language model 13 differently depending on whether the target programming language input by the user is in-domain or out-of-domain with respect to the language model 13. This is expressed by Equation 2 below.

$$f ( θ ) = θ + Δθ ⊙ m ⊙ ( 1 - ( l ∈ OOD ) {m}_{D} ) \qquad [ Equation 2 ]$$

Here, [symbol] (l∈OOD), which is an indicator representing whether a target programming language l belongs to an out-of-domain (OOD) category or not (i.e., an in-domain category), has a value of 1 if the target programming language is out-of-domain, and 0 if the target programming language is in-domain. Additionally, m_{D}, which is a value indicating whether a layer to be updated is a dense layer, is 0 if the layer to be updated is a dense layer, and is 0 otherwise. Notably, a dense layer refers to a fully connected layer in a neural network, where all input neurons are connected to output neurons, and is a layer of great importance in the performance of the language model 13.

That is, according to Equation 2, element-wise multiplication is performed between the variations of parameters, determined as shown in Equation 1, and their masking result, additionally considering whether the target programming language is in-domain or out-of-domain, as well as whether the layer to be updated is a dense layer. First, if the target programming language is in-domain, [symbol] (l∈OOD) is 0, making Equation 2 identical to Equation 1. However, if the target programming language is out-of-domain, [symbol] (l∈OOD) is 1, and the value of m_{D} needs to be considered. If the layer to be updated is a dense layer, m_{D} is 0, making Equation 2 identical to Equation 1. On the other hand, if the layer to be updated is not a dense layer, m_{D} is 1, making the term Δθ ⊙m⊙ (1- [symbol] (l∈OOD)m_{D}) in Equation 2 become 0, and thus, no parameter update is performed.

In other words, if the target programming language is in-domain, the computing device 12 may update the pretrained parameters of all layers of the language model 13. If the target programming language is out-of-domain, the computing device 12 may update only the pretrained parameters of a dense layer of the language model 13. This ensures that even when the target programming language is out-of-domain, the dense layer, which is directly linked to the performance of the language model 13, can be selectively updated, thereby ensuring a minimum level of code snippet generation accuracy.

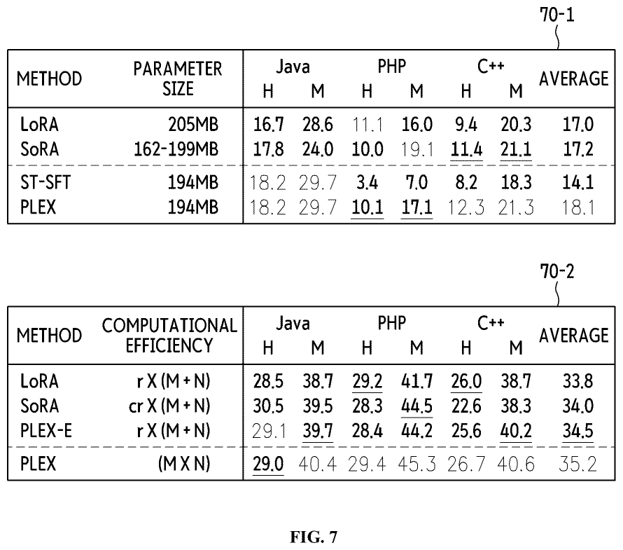

Meanwhile, if the number of pretrained parameters of the language model 13 exceeds a predefined threshold (i.e., if the language model 13 corresponds to an LLM), it may take an excessively long time to perform full fine-tuning to generate the masking result of the pretrained parameters of the language model 13. Accordingly, in the case of an LLM, a low-rank update of the weight of the dense layer may be performed first, followed by generating the masking result of pretrained parameters using the aforementioned method. A low-rank update is also referred to as a low-rank decomposition. If the weight of a dense layer is denoted as W ∈ [symbol] ^{a×b}, the result of performing a low-rank update may be expressed as W=WᵤW_{d}(Wᵤ∈ [symbol] ^{a×r}, W_{d}∈ [symbol] ^{r×b}). That is, by adjusting the value of r through a low-rank update, the time required for generating the masking result of pretrained parameters in an LLM can be reduced. This will be further described later with reference to FIG. 7.

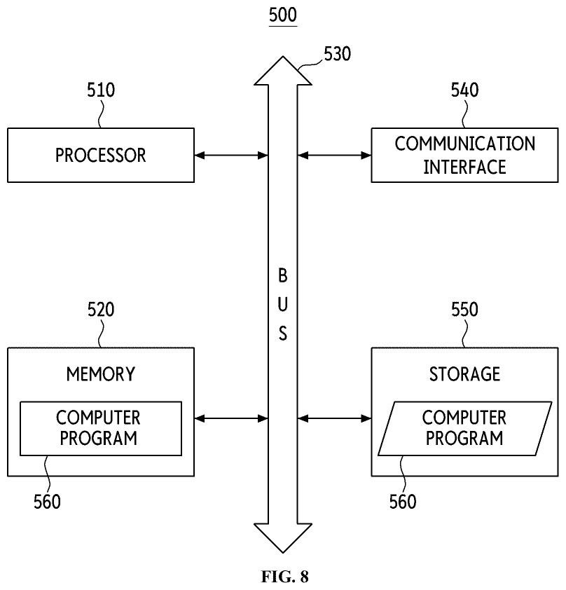

The computing device 12 may be configured using one or more physical servers included in a server farm, based on cloud technology such as virtual machine. The specific configuration and operation of the computing device 12 will be described later with reference to FIG. 8.

The components illustrated in FIG. 1 may communicate via a network. For example, the network may be implemented as any type of wired or wireless network, such as a Local Area Network (LAN), a Wide Area Network (WAN), a mobile radio communication network, or Wireless Broadband Internet (WiBro).

Hereinafter, embodiments regarding the adjustment of the language model 13 will be examined.

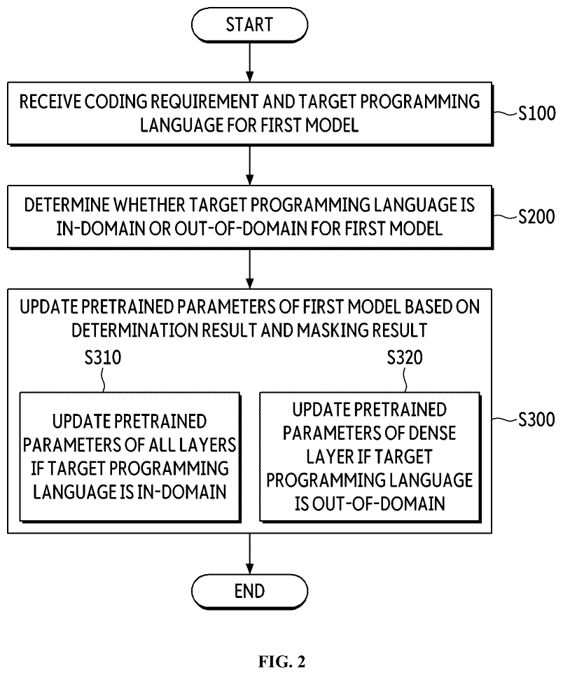

FIG. 2 is a flowchart illustrating a method for tuning a language model according to an embodiment of the present disclosure. Specifically, FIG. 2 and FIGS. 3 through 6 illustrate steps/operations performed in the computing device 12 of FIG. 1 or a computing device 500 of FIG. 8. Accordingly, in the following description, if the subject of a particular step/operation is omitted, it may be understood that the step/operation is performed in the computing device 12 of FIG. 1 or the computing device 500 of FIG. 8.

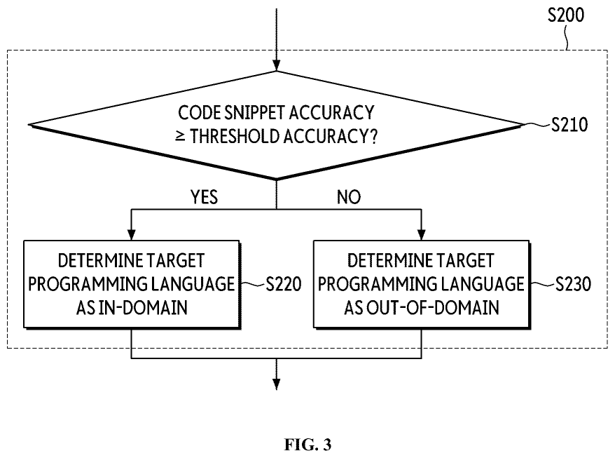

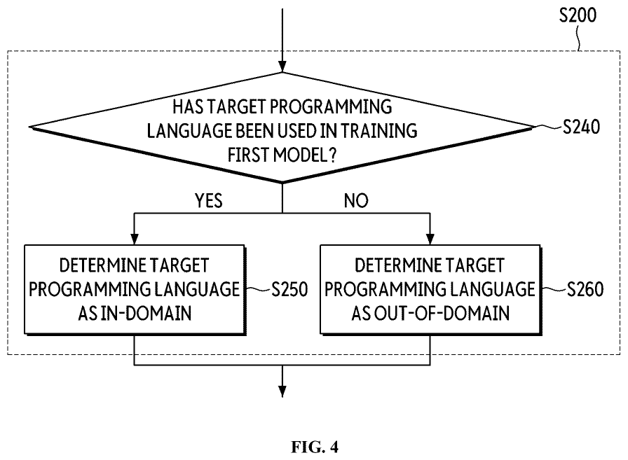

In step S100, a coding requirement and a target programming language to be input into a first model may be received from a user. Here, the first model may correspond to a neural network model trained to output a code snippet corresponding to the received coding requirement in the target programming language. Thereafter, in step S200, a determination may be made as to whether the target programming language is in-domain or out-of-domain with respect to the first model. Embodiments regarding step S200 will be described with reference to FIGS. 3 and 4.

FIG. 3 is a flowchart illustrating an embodiment of step S200 in FIG. 2, where a determination is made as to whether the target programming language is in-domain or out-of-domain. Referring to FIG. 3, in step S210, a determination may be made as to whether the accuracy of a previously generated code snippet in the target programming language is equal to or greater than a predefined threshold accuracy. In step S220, if the accuracy of the previously generated code snippet in the target programming language is equal to or greater than the predefined threshold accuracy (“YES”), the target programming language may be determined to be in-domain. In step S230, if the accuracy of the previously generated code snippet in the target programming language is below the predefined threshold accuracy (“NO”), the target programming language may be determined to be out-of-domain.

FIG. 4 is a flowchart illustrating another embodiment of step S200 in FIG. 2, where a determination is made as to whether the target programming language is in-domain or out-of-domain. Referring to FIG. 4, in step S240, a determination may be made as to whether the target programming language has been used in training the first model. In step S250, if the target programming language has been used in training the first model (“YES”), the target programming language may be determined to be in-domain. In S260, if the target programming language has not been used in training the first model (“NO”), the target programming language may be determined to be out-of-domain.

Generally, the embodiment of FIG. 3 may be used to distinguish between in-domain and out-of-domain languages in the tuning process of an LLM, whereas the embodiment of FIG. 4 may be used to distinguish between in-domain and out-of-domain languages in the tuning process of a general language model rather than an LLM. However, the present disclosure is not limited to this.

Referring back to FIG. 2, in step S300, the pretrained parameters may be updated based on the result of the determination performed in step S200 and the masking result of the pretrained parameters of the first model, and this process may correspond to the tuning of the first model. Here, the masking result may refer to a result in which, among the pretrained parameters of the first model, those whose variation, as a result of a previously performed full fine-tuning on the first model, is equal to or greater than a predefined threshold variation are masked as 1, and those whose variation is below the predefined threshold variation are masked as 0. Meanwhile, if the number of pretrained parameters of the first model exceeds a predefined threshold (i.e., if the first model corresponds to an LLM), the aforementioned full fine-tuning may be performed after performing a low-rank update on the weight of a dense layer of the first model.

Specifically, in step S310, if the target programming language is determined to be in-domain, the pretrained parameters of all layers of the first model may be updated. In step S320, if the target programming language is determined to be out-of-domain, only the pretrained parameters of the dense layer of the first model may be updated.

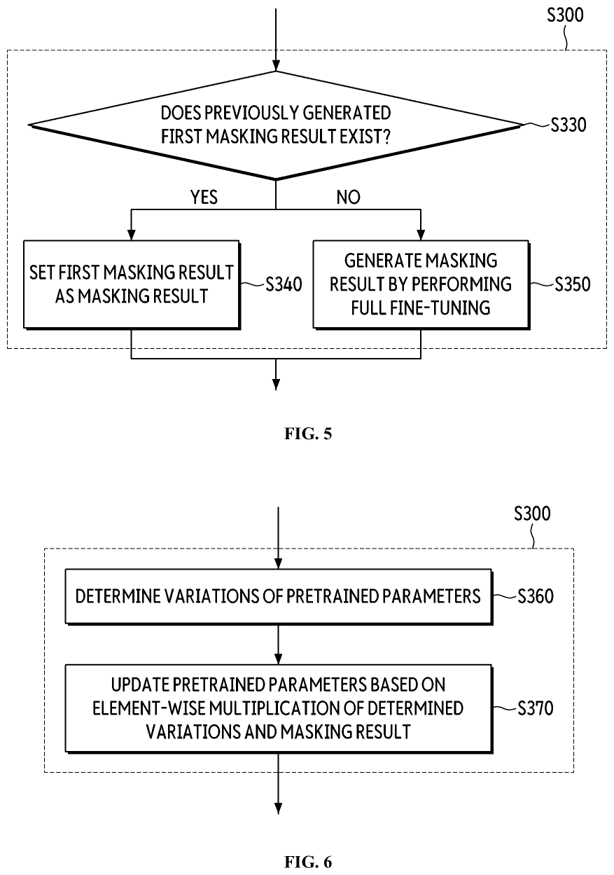

Embodiments regarding step S300 will be described with reference to FIGS. 5 and 6.

FIG. 5 is a flowchart illustrating an embodiment of step S300 in FIG. 2, where the pretrained parameters of the first model are updated. 2. Referring to FIG. 5, in step S330, a determination may be made as to whether there exists a first masking result previously generated during the training of the first model using a first coding requirement and a first programming language. Here, the first coding requirement may refer to a coding requirement having a similarity equal to or greater than a predefined threshold similarity to the received coding requirement, and the first programming language may refer to the same language as the target programming language.

In step S340, if the first masking result exists (“YES”), the first masking result may be selected as the masking result, and step S300 may be performed. On the other hand, in step S350, if the first masking result does not exist (“NO”), a new full fine-tuning may be performed on the first model, and a masking result may be generated in which, among the pretrained parameters of the first model, those whose variation is equal to or greater than a predefined threshold variation may be masked as 1 and those whose variation is below the predefined threshold variation may be masked as 0.

FIG. 6 is a flowchart illustrating another embodiment of step S300 in FIG. 2, where the pretrained parameters of the first model are updated. Referring to FIG. 6, in step S360, the variations of the pretrained parameters (i.e., parameters to be updated) may be determined. Thereafter, in step S370, the pretrained parameters may be updated based on the element-wise multiplication of the determined variations and the masking result. Steps S310 through S320 in FIG. 2 may be performed together with S360 and S370 in FIG. 6 in accordance with Equations 1 and 2, described above with reference to FIG. 1.

FIG. 7 shows the effects of methods for tuning a language model according to embodiments of the present disclosure for each programming language. Specifically, FIG. 7 shows various language model tuning methods and their effects for each programming language (i.e., Java, PHP, and C++). In FIG. 7, low-rank adaption (LoRA), sparse low-rank adaptation (SoRA), and lottery ticket sparse fine-tuning (LT-SFT) correspond to conventional methods prior to the method for tuning a language model according to an embodiment of the present disclosure, PLEX corresponds to a language model tuning model according to an embodiment of the present disclosure, and PLEX-E corresponds to a language model tuning model according to an embodiment of the present disclosure using a low-rank update. “H” and “M” respectively denote HumanEval and Mostly Basic Python Programming, which are metrics for evaluating the performance of a language model in generating a code snippet. Additionally, in FIG. 7, Java is assumed to be an in-domain programming language, whereas PHP and C++ are assumed to be out-of-domain programming languages.

Referring first to Table 70-1, PLEX show relatively high language model performance evaluation metric values with the highest average for PHP and C++, which are out-of-domain programming languages. Additionally, referring to Table 70-2, as with Table 70-1, PLEX also shows relatively high language model performance evaluation metric values with the highest average for PHP and C++, which are out-of-domain programming languages. Meanwhile, PLEX-E exhibits slightly lower language model performance evaluation metric values than PLEX, but has a computation efficiency of r(M+N), which is a significant improvement compared to the computation efficiency of PLEX, which is calculated as M*N, resulting in a substantial reduction in computational time.

FIG. 8 is a block diagram illustrating the hardware configuration of the computing device 500 including a language model according to an embodiment of the present disclosure.

Referring to FIG. 8, the computing device 500 may include at least one processor 510, a bus 530, a communication interface 540, a memory 520 that loads a computer program 560 executed by the processor 510, and a storage 550 that stores the computer program 560. However, FIG. 8 illustrates only components relevant to embodiments of the present disclosure. Accordingly, one of ordinary skill in the art may understand that the computing device 500 may include additional general-purpose components other than those illustrated in FIG. 8. That is, the computing device 500 may include various additional components beyond those illustrated in FIG. 8. Additionally, in some embodiments, the computing device 500 may be configured with some of the illustrated components omitted. Each component of the computing device 500 will hereinafter be described.

The processor 510 may control the overall operation of each component of the computing device 500. The processor 510 may include at least one of a Central Processing Unit (CPU), a Micro Processor Unit (MPU), a Micro Controller Unit (MCU), a Graphics Processing Unit (GPU), or any other type of processor well known in the technical field of the present disclosure. Additionally, the processor 510 may perform computation for executing at least one application or program for implementing operations/methods according to embodiments of the present disclosure. The computing device 500 may include one or more processors 510.

The memory 520 may store various data, commands, and/or information. The memory 520 may load the computer program 560 from the storage 550 to execute the operations/methods according to embodiments of the present disclosure. The memory 520 may be implemented as a volatile memory such as Random-Access Memory (RAM), but is not limited thereto.

The bus 530 may provide communication functionality between the components of the computing device 500. The bus 530 may be implemented as various types of buses, including an address bus, a data bus, or a control bus.

The communication interface 540 may support wired and wireless internet communication of the computing device 500. Additionally, the communication interface 540 may support various communication methods other than internet communication. To this end, the communication interface 540 may include a communication module well known in the technical field of the present disclosure.

The storage 550 may non-transiently store at least one computer program 560. The storage 550 may be implemented as a non-volatile memory such as Read-Only Memory (ROM), Erasable Programmable ROM (EPROM), Electrically Erasable Programmable ROM (EEPROM), flash memory, a hard disk, a removable disk, or any other type of computer-readable recording medium well known in the technical field of the present disclosure.

The computer program 560 may include one or more instructions that, when loaded into the memory 520, cause the processor 510 to perform the operations/methods according to embodiments of the present disclosure. That is, by executing the loaded instructions, the processor 510 may perform the operations/methods according to embodiments of the present disclosure.

For example, the computer program 560 may include instructions for performing the operations of: receiving, from a user, a coding requirement and a target programming language to be input into a first model; determining whether the target programming language is in-domain or out-of-domain with respect to the first model; and updating pretrained parameters of the first model based on the result of the determination and a masking result of the pretrained parameters. Here, the first model is a model trained to output a code snippet corresponding to the received coding requirement in the target programming language. The updating the pretrained parameters may include updating pretrained parameters of all layers of the first model when the target programming language is in-domain, and updating only pretrained parameters of a dense layer of the first model when the target programming language is out-of-domain.

According to embodiments of the present disclosure, in a language model trained to generate a code snippet, adjustments can be efficiently made during inference for both in-domain and out-of-domain programming languages. Additionally, according to embodiments of the present disclosure, masking can selectively update parameters of high importance while preventing omission of updates to a dense layer of the language model. In particular, since parameter updates are performed only on the dense layer when an out-of-domain programming language is used, the performance of the language model can be maintained above a certain level. Furthermore, according to embodiments of the present disclosure, by using a low-rank update, computational time can be reduced, ensuring both high accuracy and low computational cost in the process of tuning the language model for code snippet generation.

Various embodiments and the effects thereof according to the present disclosure have been mentioned with reference to FIGS. 1 through 8. The effects according to the technical spirit of the present disclosure are not limited to those mentioned above, and other effects not mentioned will be clearly understood by one of ordinary skill in the art from the description below.

While all components comprising the embodiments of the present disclosure have been described as being combined or operating in conjunction, it should not be understood that the present disclosure is limited to such embodiments. That is, within the scope of the objectives of the present disclosure, all such components can selectively be combined and operate in one or more configurations.

Although operations are illustrated in a specific order in the drawings, it should not be understood that the operations must be performed in that specific order or sequentially, or that all the illustrated operations are required to achieve desired results. In certain circumstances, multitasking and parallel processing may be advantageous. Furthermore, the separation of various components in the described embodiments should not be understood as necessary, and the described program components and systems can generally be integrated into a single software product or packaged into multiple software products.

While the embodiments of the present disclosure have been described with reference to the attached drawings, it will be understood by one skilled in the art that the present disclosure can be implemented in other specific forms without departing from the technical spirit or essential characteristics thereof. Therefore, the described embodiments should be considered in all respects as illustrative and not restrictive. The scope of the present disclosure is to be interpreted by the following claims, and all technical spirits within the equivalent scope are to be interpreted as included within the rights of the present disclosure.

What is claimed is:

1. A method for tuning a language model, performed by a computing device, the method comprising:
receiving, from a user, a coding requirement and a target programming language to be input into a first model, wherein the first model is a model trained to output a code snippet corresponding to the received coding requirement in the target programming language;
determining whether the target programming language is in-domain or out-of-domain with respect to the first model; and
updating pretrained parameters of the first model based on a result of the determination and a masking result of the pretrained parameters,
wherein the updating the pretrained parameters comprises: updating pretrained parameters of all layers of the first model when the target programming language is in-domain; and updating pretrained parameters of a dense layer of the first model when the target programming language is out-of-domain.

2. The method of claim 1, wherein the determining whether the target programming language is in-domain or out-of-domain comprises: determining that the target programming language is in-domain when an accuracy of a previously generated code snippet in the target programming language is equal to or greater than a predefined threshold accuracy; and determining that the target programming language is out-of-domain when the accuracy of the previously generated code snippet is below the predefined threshold accuracy.

3. The method of claim 1, wherein the determining whether the target programming language is in-domain or out-of-domain comprises: determining that the target programming language is in-domain when the target programming language has been used in training the first model; and determining that the target programming language is out-of-domain when the target programming language has not been used in training the first model.

4. The method of claim 1, wherein the masking result is a result in which, among the pretrained parameters, parameters whose variation, as a result of a previously performed full fine-tuning on the first model, is equal to or greater than a predefined threshold variation are masked as 1, and parameters whose variation is below the predefined threshold variation are masked as 0.

5. The method of claim 4, wherein, when a number of pretrained parameters of the first model exceeds a predefined threshold, the full fine-tuning is performed in advance using a low-rank update on a weight of the dense layer of the first model.

6. The method of claim 1, wherein the updating the pretrained parameters comprises: determining whether there exists a first masking result previously generated during training of the first model using a first coding requirement and a first programming language, wherein the first coding requirement is a requirement having a similarity equal to or greater than a predefined threshold similarity to the received coding requirement, and the first programming language is the same as the target programming language; and when the first masking result exists, determining the first masking result as the masking result, and when the first masking result does not exist, performing a full fine-tuning on the first model and generating the masking result by masking, among the pretrained parameters, parameters whose variation, as a result of the full fine-tuning, is equal to or greater than a predefined threshold variation as 1 and parameters whose variation is below the predefined threshold variation as 0.

7. The method of claim 1, wherein the updating the pretrained parameters comprises: determining variations of the pretrained parameters; and updating the pretrained parameters based on element-wise multiplication of the determined variations and the masking result.

8. A system for tuning a language model comprising:
a processor; and
a memory storing instructions,
wherein the instructions, when executed by the processor, cause the processor to: receive, from a user, a coding requirement and a target programming language to be input into a first model, wherein the first model is a model trained to output a code snippet corresponding to the received coding requirement in the target programming language; determine whether the target programming language is in-domain or out-of-domain with respect to the first model; and update pretrained parameters of the first model based on a result of the determination and a masking result of the pretrained parameters, and
wherein the updating the pretrained parameters comprises: updating pretrained parameters of all layers of the first model when the target programming language is in-domain; and updating pretrained parameters of a dense layer of the first model when the target programming language is out-of-domain.

9. The system of claim 8, wherein the determining whether the target programming language is in-domain or out-of-domain comprises: determining that the target programming language is in-domain when an accuracy of a previously generated code snippet in the target programming language is equal to or greater than a predefined threshold accuracy; and determining that the target programming language is out-of-domain when the accuracy of the previously generated code snippet is below the predefined threshold accuracy.

10. The system of claim 8, wherein the determining whether the target programming language is in-domain or out-of-domain comprises: determining that the target programming language is in-domain when the target programming language has been used in training the first model; and determining that the target programming language is out-of-domain when the target programming language has not been used in training the first model.

11. The system of claim 8, wherein the masking result is a result in which, among the pretrained parameters, parameters whose variation, as a result of a previously performed full fine-tuning on the first model, is equal to or greater than a predefined threshold variation are masked as 1, and parameters whose variation is below the predefined threshold variation are masked as 0.

12. The system of claim 11, wherein, when a number of pretrained parameters of the first model exceeds a predefined threshold, the full fine-tuning is performed in advance using a low-rank update on a weight of the dense layer of the first model.

13. The system of claim 8, wherein the updating the pretrained parameters comprises: determining whether there exists a first masking result previously generated during training of the first model using a first coding requirement and a first programming language, wherein the first coding requirement is a requirement having a similarity equal to or greater than a predefined threshold similarity to the received coding requirement, and the first programming language is the same as the target programming language; and when the first masking result exists, determining the first masking result as the masking result, and when the first masking result does not exist, performing a full fine-tuning on the first model and generating the masking result by masking, among the pretrained parameters, parameters whose variation, as a result of the full fine-tuning, is equal to or greater than a predefined threshold variation as 1 and parameters whose variation is below the predefined threshold variation as 0.

14. The system of claim 8, wherein the updating the pretrained parameters comprises: determining variations of the pretrained parameters; and updating the pretrained parameters based on element-wise multiplication of the determined variations and the masking result.

15. A non-transitory computer-readable recording medium storing instructions that, when executed in conjunction with a computing device, cause the computing device to:
receive, from a user, a coding requirement and a target programming language to be input into a first model, wherein the first model is a model trained to output a code snippet corresponding to the coding requirement in the target programming language;
determine whether the target programming language is in-domain or out-of-domain with respect to the first model; and
update pretrained parameters of the first model based on a result of the determination and a masking result of the pretrained parameters,
wherein the updating the pretrained parameters comprises: updating pretrained parameters of all layers of the first model when the target programming language is in-domain; and updating pretrained parameters of a dense layer of the first model when the target programming language is out-of-domain.

16. The non-transitory computer-readable recording medium of claim 15, wherein the determining whether the target programming language is in-domain or out-of-domain comprises: determining that the target programming language is in-domain when an accuracy of a previously generated code snippet in the target programming language is equal to or greater than a predefined threshold accuracy; and determining that the target programming language is out-of-domain when the accuracy of the previously generated code snippet is below the predefined threshold accuracy.

17. The non-transitory computer-readable recording medium of claim 15, wherein the determining whether the target programming language is in-domain or out-of-domain comprises: determining that the target programming language is in-domain when the target programming language has been used in training the first model; and determining that the target programming language is out-of-domain when the target programming language has not been used in training the first model.

18. The non-transitory computer-readable recording medium of claim 15, wherein the masking result is a result in which, among the pretrained parameters, parameters whose variation, as a result of a previously performed full fine-tuning on the first model, is equal to or greater than a predefined threshold variation are masked as 1, and parameters whose variation is below the predefined threshold variation are masked as 0.

19. The non-transitory computer-readable recording medium of claim 18, wherein, when a number of pretrained parameters of the first model exceeds a predefined threshold, the full fine-tuning is performed in advance using a low-rank update on a weight of the dense layer of the first model.

20. The non-transitory computer-readable recording medium of claim 15, wherein the updating the pretrained parameters comprises: determining whether there exists a first masking result previously generated during training of the first model using a first coding requirement and a first programming language, wherein the first coding requirement is a requirement having a similarity equal to or greater than a predefined threshold similarity to the received coding requirement, and the first programming language is the same as the target programming language; and when the first masking result exists, determining the first masking result as the masking result, and when the first masking result does not exist, performing a full fine-tuning on the first model and generating the masking result by masking, among the pretrained parameters, parameters whose variation, as a result of the full fine-tuning, is equal to or greater than a predefined threshold variation as 1 and parameters whose variation is below the predefined threshold variation as 0.

21. The non-transitory computer-readable recording medium of claim 15, wherein the updating the pretrained parameters comprises: determining variations of the pretrained parameters; and updating the pretrained parameters based on element-wise multiplication of the determined variations and the masking result.
